(19) United States
(12) Patent Application Publication
(10) Pub. No.: US 2026/0031847 A1
(43) Pub. Date: Jan. 29, 2026

(54) Redundant And Co-Operative Multi-Radio Communication In Aerial Vehicles

(71) Applicant: Skydio, Inc., San Mateo, CA (US)

(72) Inventors: Oleg Tolstov, San Mateo, CA (US); Eyal Hochdorf, Palo Alto, CA (US); Abraham Galton Bachrach, Emerald Hills, CA (US)

(21) Appl. No.: 19/280,183

(22) Filed: Jul. 25, 2025

Related U.S. Application Data
(60) Provisional application No. 63/675,632, filed on Jul. 25, 2024.

(51) Int. Cl. H04B 1/3827; B64U 10/14; B64U 20/87; B64U 101/20; H04B 17/309

(52) U.S. Cl. CPC H04B 1/3827; B64U 10/14; B64U 20/87; H04B 17/309; B64U 2101/20; B64U 2201/104

(57) ABSTRACT

A multi-radio communication system for drones enables enhanced reliability and throughput by concurrently utilizing distinct radio technologies, such as cellular (e.g., LTE, 5G) and point-to-point wireless links (e.g., Wi-Fi). A communication management module dynamically selects between single, cooperative, and redundant transmission modes based on operational context parameters, communication link quality metrics, or other application requirements. In cooperative mode, unique data packets are distributed across both links to maximize throughput; in redundant mode, identical packets are sent concurrently to improve reliability. An error correction module aggregates data from multiple links to reconstruct complete messages and recover lost packets. The system adapts intelligently to varying mission demands and environmental conditions, providing robust, low-latency communication suitable for critical drone operations such as public safety surveillance, disaster response, and tactical deployments.

### CROSS-REFERENCE TO RELATED APPLICATION(S)

This application claims the benefit of U.S. Provisional Patent Application No. 63/675,632, filed Jul. 25, 2024, the entire disclosure of which is hereby incorporated by reference.

### TECHNICAL FIELD

This disclosure relates to unmanned aerial vehicles (UAVs), and more specifically, to enhanced communication using redundant and co-operative using different radio technologies in UAVs.

### BACKGROUND

The advent of drones or unmanned aerial vehicles (UAVs) has revolutionized various sectors, including telecommunications and computer networks. Drones are increasingly being used for applications such as package delivery, surveillance, and disaster response, among others. The communication link between the controlling device and the drone is crucial for the safe and efficient operation of these drones. This communication link is typically established using wireless technologies such as Long-Term Evolution (LTE) and Wi-Fi. Both of these technologies have their own advantages and disadvantages, with LTE being known for its high data rates and wide coverage, while Wi-Fi is known for its high data rates and low cost.

Existing solutions in this field primarily focus on optimizing the performance of a single radio technology. For instance, some solutions propose to optimize the performance of LTE by improving its spectral efficiency or reducing its latency. Similarly, other solutions propose to optimize the performance of Wi-Fi by improving its signal strength or reducing its interference. Some solutions also propose to use multiple radios simultaneously to improve the reliability of the communication link. However, these solutions typically involve the use of multiple radios of the same technology, rather than combining two different radio technologies. Traditional communication systems relying on a single radio technology can be susceptible to limitations such as interference, signal degradation, and bandwidth constraints. For instance, LTE may not provide sufficient coverage in certain areas, while Wi-Fi may be susceptible to interference from other devices. These limitations can significantly impact the performance and reliability of communication links, especially in challenging environments where robust and uninterrupted communication is essential. These and other drawbacks exist with single-radio technologies.

### SUMMARY

Existing solutions primarily focus on optimizing the performance of a single radio technology. In contrast, the present system leverages multiple radios based on different radio technologies, such as LTE or 5G for cellular communication and Wi-Fi or proprietary RF for point-to-point wireless communication. This separation ensures diversity in spectral domains, network infrastructure, and signal propagation, increasing robustness in conditions where one technology may degrade while the other remains effective.

In some aspects, the techniques described herein relate to a communication system for a drone, including: a first radio transceiver configured for operation over a cellular network; a second radio transceiver configured for operation over a point-to-point wireless network; and a communication management module configured to: determine a transmission mode for transmitting data packets using both the transceivers concurrently, the transmission mode including a co-operative mode in which distinct data packets are transmitted over each transceiver, or a redundant mode in which identical data packets are transmitted over each transceiver, and cause selective transmission of the data packets over each transceiver based on the transmission mode.

In some aspects, the techniques described herein relate to a method for enhancing communication reliability in a drone, the method including: activating a cellular radio transceiver and a point-to-point radio transceiver on a drone for enabling communication using a cellular network and a point-to-point wireless network; transmitting data packets of a message from a controlling device to the drone via at least one of the cellular network and the point-to-point wireless network, wherein the transmitting includes: determining, for each data transmission instance, a transmission mode, the transmission mode indicating whether to send data over both networks concurrently or one of the networks, and dynamically adjusting allocation of data between the networks based on the transmission mode; and reconstructing the message at the drone based on the data packets received from either or both networks.

In some aspects, the techniques described herein relate to an autonomous unmanned aerial vehicle (UAV) including: one or more sensors configured to capture perception inputs of a physical environment; a propulsion system configured to maneuver the UAV through the physical environment; a communication system including: a first radio transceiver configured for operation over a cellular network, and a second radio transceiver configured for operation over a point-to-point wireless network; and a communication management module configured to: select a transmission mode for transmitting data packets using both the transceivers, the transmission mode including a co-operative mode in which distinct data packets are transmitted over each transceiver, or a redundant mode in which identical data packets are transmitted over each transceiver.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example configuration of a top side of an unmanned aerial vehicle (UAV), consistent with various embodiments.

FIG. 2 illustrates an example configuration of a bottom side of the UAV, consistent with various embodiments.

FIG. 3 illustrates an example UAV architecture for a UAV configured with improved resilience against electronic warfare (EW), consistent with various embodiments.

FIG. 4 illustrates a multi-radio communication system for drones, consistent with various embodiments.

FIG. 5 is a flow diagram of a method for enhancing drone communication using multi-radio technologies, consistent with various embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

Disclosed are embodiments for multi-radio communication system for drones, including a first radio transceiver, such as a cellular transceiver, and a second radio transceiver, such as a Wi-Fi transceiver or other point-to-point (P2P) wireless transceiver. The cellular transceiver can operate over a cellular network such as long term evolution (LTE), 5G, or other cellular communication standards. The P2P wireless transceiver may operate over Wi-Fi or other wireless communication standards that support direct device-to-device connectivity, including but not limited to Wi-Fi Direct, or proprietary RF protocols. The communication system may concurrently activate both radio links, such as LTE and Wi-Fi, or 5G and proprietary RF, to establish reliable communication.

The communication system may transmit or receive data using one transceiver or both transceivers concurrently. A communication management module may manage concurrent transmission or reception in either: (a) a cooperative mode, where unique, non-redundant data packets are transmitted over both communication links, or (b) a redundant mode, where identical data packets are transmitted over each communication link. The communication management module may dynamically allocate data to one or both transceivers based on various conditions. In some embodiments, data allocation may be influenced by an operational context parameter of the drone mission, such as requirements for reliability, throughput, latency, or power consumption. For example, when a mission prioritizes throughput, the communication system may transmit data in a cooperative mode-for instance, a first portion of the message may be transmitted over the first communication link (e.g., cellular network) using the cellular transceiver and a second portion of the message over the second communication link (e.g., Wi-Fi network) using the P2P transceiver, concurrently. In another example, when the mission prioritizes reliability, the communication system may transmit data in a redundant mode-for instance, a message may be transmitted to the drone by sending all data packets of the message over the first and the second communication links concurrently.

In some embodiments, the communication system may allocate data to one or both transceivers based on a communication link quality metric like signal strength, interference, bandwidth availability, etc. For example, redundant mode data transmission may be employed when a communication link quality metric (e.g., signal strength) for either communication link falls below a predefined threshold, thereby improving reliability by reducing likelihood of data loss. In another example, co-operative mode data transmission may be employed when a communication link quality metric (e.g., signal strength) of both communication links meet specified thresholds, thereby improving throughput.

Accordingly, the communication system can selectively route data packets over each transceiver to optimize data transmission, either by transmitting identical packets for redundancy or distinct packets for increased throughput. An error correction mechanism may aggregate data packets received across both communication links to ensure data integrity. A drone equipped with such a communication system may be deployed in applications requiring robust communication links, such as urban search and rescue, long-range public safety surveillance, or tactical operations.

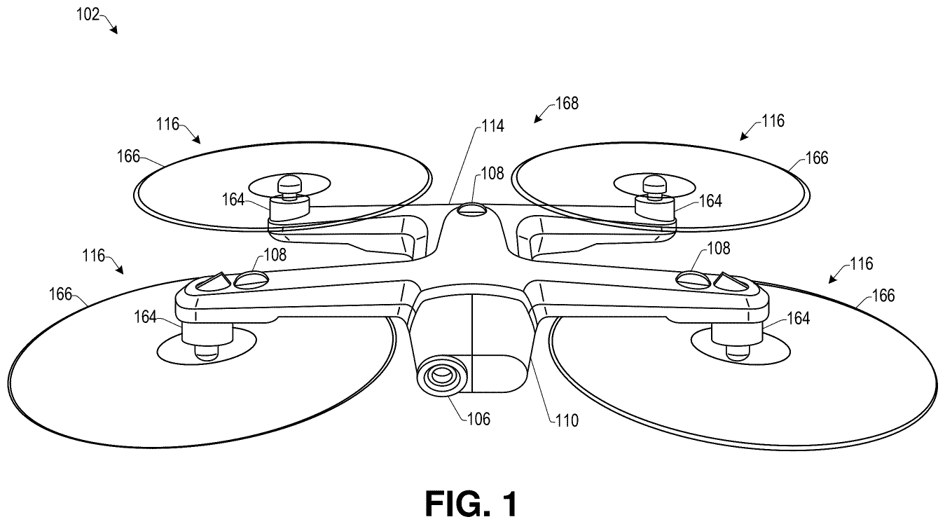

FIG. 1 illustrates an example configuration of a top side of an UAV, consistent with various embodiments. In this example, the UAV 102 includes a propulsion system 116 including four motors 164 and propellers 166 that is configured to maneuver the UAV through a physical environment. In this example, the UAV 102 is illustrated as a quadcopter drone, but implementations herein are not limited to such.

The UAV 102 includes a plurality of the second cameras 108 mounted on the body 114 of the UAV 102 and that may be used as navigation cameras in some cases. The UAV 102 further includes the aimable first camera 106 that may include a higher-resolution image sensor than the image sensors of the wider-angle cameras 108. In some cases, the first camera 106 includes a fixed focal length lens. In other cases, the first camera 106 may include a mechanically controllable, optically zoomable lens. The first camera 106 is mounted on the gimbal 110 that enables aiming of the first camera 106 in approximately a 180-degree hemispherical area to support steady, low-blur image capture and object tracking. For example, the first camera 106 may be used for capturing high resolution images of target objects, providing object tracking video, or various other operations.

In this example, three second cameras 108 are spaced out around the top side 168 of the UAV 102 and covered by respective fisheye lenses to provide a wide field of view and to support stereoscopic computer vision. The wider-angle cameras 108 on the top side 168 of the UAV 102, as well as those on the bottom side discussed below, may be precisely calibrated with respect to each other following installation on the body 114 of the UAV 102. As a result of the calibration, for each pixel in each of the images captured by the respective wider-angle cameras, the precise corresponding three-dimensional (3D) orientation with respect to a virtual sphere surrounding the UAV may be determined in advance. In some cases, six wider-angle cameras 108 are employed with a field of view (FOV) sufficiently wide (e.g., 180-degree FOV, 200-degree FOV, etc.) and are positioned on the body 114 of the UAV 102 for covering the entire spherical space around the UAV 102.

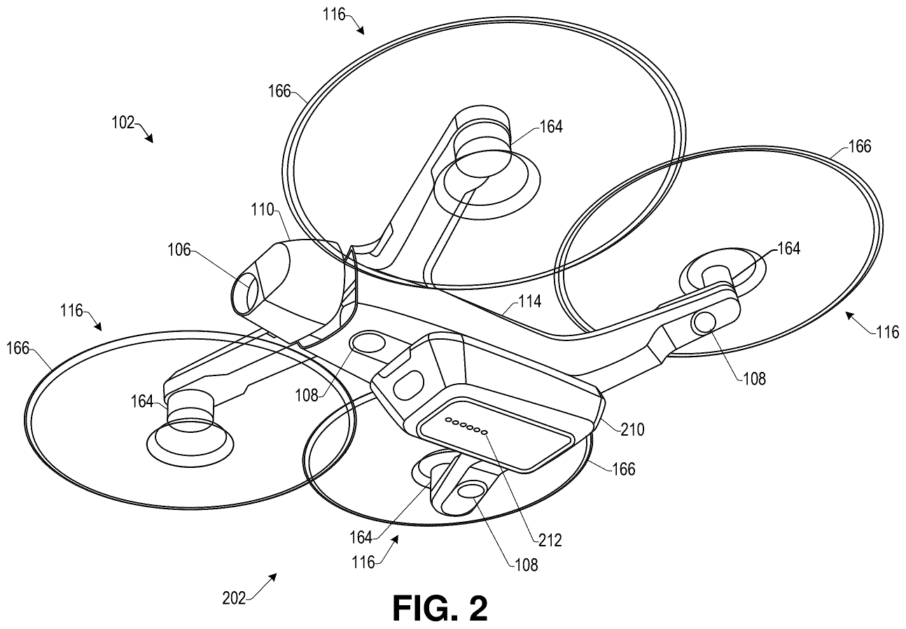

FIG. 2 illustrates an example configuration of a bottom side of the UAV, consistent with various embodiments. From this perspective three more second cameras 108 arranged on the bottom side 202 of the UAV 102 are illustrated. The second cameras 108 on the bottom side 202 may also be covered by respective fisheye lenses to provide a wide field of view and to support stereoscopic computer vision. This array of second cameras 108 (e.g., three on the top side and three on the bottom side of the UAV 102) may enable visual inertial odometry (VIO) for high resolution localization and obstacle detection and avoidance. For example, the array of second cameras 108 may be used to scan a surrounding area to obtain range data and provide image information that can be used to generate range maps indicating distances to objects detected in the FOVs of the second cameras 108, such as for use during autonomous navigation of the UAV 102 or for determining the distance of surfaces from the UAV 102.

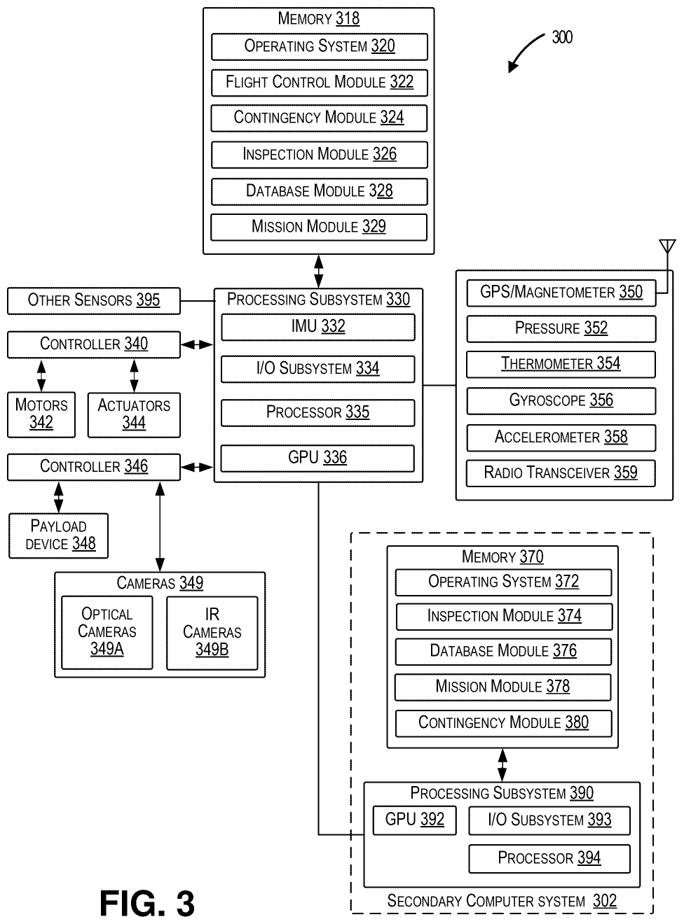

The UAV 102 may also include a battery pack 210 attached on the bottom side 202 of the UAV 102, with conducting contacts 212 to enable battery charging. The UAV 102 also includes an internal processing apparatus including one or more processors and a computer-readable medium (not shown in FIG. 2) as well as various other electronic and mechanical components. For example, the UAV 102 may include a hardware configuration as discussed with respect to FIG. 3 below.

FIG. 3 illustrates an example UAV architecture for a UAV configured with improved resilience against EW, consistent with various embodiments. In the examples herein, the UAV 102 may sometimes be referred to as a “drone” and may be implemented as any type of UAV capable of controlled flight without a human pilot onboard. For instance, the UAV 102 may be controlled autonomously by one or more onboard processors, such as processor 335, that execute one or more executable programs. Additionally, or alternatively, the UAV 102 may be controlled via a remote controller, such as through a remotely located controller operated by a human pilot and/or controlled by an executable program executing on or in cooperation with the controller.

A UAV can include a primary computer system 300 and a secondary computer system 302. The UAV primary computer system 300 can be a system of one or more computers, or software executing on a system of one or more computers, which is in communication with, or maintains, one or more databases. The UAV primary computer system 300 can include a processing subsystem 330 including one or more processors 335, graphics processing units 336, I/O subsystem 334, and an inertial measurement unit (IMU) 332. In addition, the UAV primary computer system 300 can include logic circuits, analog circuits, associated volatile and/or non-volatile memory, associated input/output data ports, power ports, etc., and include one or more software processes executing on one or more processors or computers. The UAV primary computer system 300 can include memory 318.

Memory 318 may include non-volatile memory, such as one or more magnetic disk storage devices, solid-state hard drives, or flash memory. Other volatile memory such as RAM, DRAM, SRAM may be used for temporary storage of data while the UAVis operational. Databases may store information describing UAV flight operations, flight plans, contingency events, geofence information, component information and other information.

The UAV primary computer system 300 may be coupled to one or more sensors, such as global navigation satellite system (GNSS) receivers 350 (e.g., GPS receivers), thermometer 354, gyroscopes 356, accelerometers 358, pressure sensors (static or differential) 352, and other sensors 395 that capture perception inputs of a physical environment. The other sensors 395 can include current sensors, voltage sensors, magnetometers, hydrometers, anemometers and motor sensors. The UAV may use IMU 332 in inertial navigation of the UAV. Sensors can be coupled to the UAV primary computer system 300, or to controller boards coupled to the UAV primary computer system 300. One or more communication buses, such as a controller area network (CAN) bus, or signal lines, may couple the various sensor and components.

Various sensors, devices, firmware and other systems may be interconnected to support multiple functions and operations of the UAV. For example, the UAV primary computer system 300 may use various sensors to determine the UAV's current geo-spatial position, attitude, altitude, velocity, direction, pitch, roll, yaw and/or airspeed and to pilot the UAV along a specified flight path and/or to a specified location and/or to control the UAV's attitude, velocity, altitude, and/or airspeed (optionally even when not navigating the UAV along a specific flight path or to a specific location).

The flight control module 322 handles flight control operations of the UAV. The module interacts with one or more controllers 340 that control operation of motors 342 and/or actuators 344. For example, the motors may be used for rotation of propellers, and the actuators may be used for flight surface control such as ailerons, rudders, flaps, landing gear and parachute deployment.

The contingency module 324 monitors and handles contingency events. For example, the contingency module 324 may detect that the UAV has crossed a boundary of a geofence, and then instruct the flight control module 322 to return to a predetermined landing location. The contingency module 324 may detect that the UAV has flown or is flying out of a visual line of sight (VLOS) from a ground operator, and instruct the flight control module 322 to perform a contingency action, e.g., to land at a landing location. Other contingency criteria may be the detection of a low battery or fuel state, a malfunction of an onboard sensor or motor, or a deviation from the flight plan. The foregoing is not meant to be limiting, as other contingency events may be detected. In some instances, if equipped on the UAV, a parachute may be deployed if the motors or actuators fail.

The mission module 329 processes the flight plan, waypoints, and other associated information with the flight plan as provided to the UAV in a flight package. The mission module 329 works in conjunction with the flight control module 322. For example, the mission module may send information concerning the flight plan to the flight control module 322, for example waypoints (e.g., latitude, longitude and altitude), flight velocity, so that the flight control module 322 can autopilot the UAV.

The UAV may have various devices connected to the UAV for performing a variety of tasks, such as data collection. For example, the UAV may carry one or more cameras 349. Cameras 349 can include one or more visible light cameras 349A, which can be, for example, a still image camera, a video camera, or a multispectral camera. The UAV may carry one or more infrared cameras 349B. Each infrared camera 349B can include a thermal sensor configured to capture one or more still or motion thermal images of an object, e.g., a solar panel. In addition, the UAV may carry a Lidar, radio transceiver, sonar, and traffic collision avoidance system (TCAS). Data collected by the devices may be stored on the device collecting the data, or the data may be stored on non-volatile memory 318 of the UAV primary computer system 300.

The UAV primary computer system 300 may be coupled to various radios, e.g., transceivers 359 for manual control of the UAV, and for wireless or wired data transmission to and from the UAV primary computer system 300, and optionally a UAV secondary computer system 302. The UAV may use one or more communications subsystems, such as a wireless communication or wired subsystem, to facilitate communication to and from the UAV. Wireless communication subsystems may include radio transceivers, infrared, optical ultrasonic and electromagnetic devices. Wired communication systems may include ports such as Ethernet ports, USB ports, serial ports, or other types of port to establish a wired connection to the UAV with other devices, such as a ground control station (GCS), flight planning system (FPS), or other devices, for example a mobile phone, tablet, personal computer, display monitor, other network-enabled devices. The UAV may use a lightweight tethered wire to a GCS for communication with the UAV. The tethered wire may be affixed to the UAV, for example via a magnetic coupler.

The UAV can generate flight data logs by reading various information from the UAV sensors and operating system 320 and storing the information in computer-readable media (e.g., non-volatile memory 318). The data logs may include a combination of various data, such as time, altitude, heading, ambient temperature, processor temperatures, pressure, battery level, fuel level, absolute or relative position, position coordinates (e.g., GPS coordinates), pitch, roll, yaw, ground speed, humidity level, velocity, acceleration, and contingency information. The foregoing is not meant to be limiting, and other data may be captured and stored in the flight data logs. The flight data logs may be stored on a removable medium. The medium can be installed on the ground control system or onboard the UAV. The data logs may be wirelessly transmitted to the ground control system or to the FPS.

Modules, programs or instructions for performing flight operations, contingency maneuvers, and other functions may be performed with operating system 320. In some implementations, the operating system 320 can be a real time operating system (RTOS), UNIX, LINUX, OS X, WINDOWS, ANDROID or other operating system 320. Additionally, other software modules and applications may run on the operating system 320, such as a flight control module 322, contingency module 324, inspection module 326, database module 328 and mission module 329. In particular, inspection module 326 can include computer instructions that, when executed by processor 335, can cause processor 335 to control the UAV to perform solar panel inspection operations as described below. Typically, flight critical functions will be performed using the UAV primary computer system 300. Operating system 320 may include instructions for handling basic system services and for performing hardware dependent tasks.

In addition to the UAV primary computer system 300, the secondary computer system 302 may be used to run another operating system 372 to perform other functions. The UAV secondary computer system 302 can be a system of one or more computers, or software executing on a system of one or more computers, which is in communication with, or maintains, one or more databases. The UAV secondary computer system 302 can include a processing subsystem 390 of one or more processors 394, GPU 392, and I/O subsystem 393. The UAV secondary computer system 302 can include logic circuits, analog circuits, associated volatile and/or non-volatile memory, associated input/output data ports, power ports, etc., and include one or more software processes executing on one or more processors or computers. The UAV secondary computer system 302 can include memory 370. Memory 370 may include non-volatile memory, such as one or more magnetic disk storage devices, solid-state hard drives, flash memory. Other volatile memory such a RAM, DRAM, SRAM may be used for storage of data while the UAV is operational.

Ideally, modules, applications and other functions running on the secondary computer system 302 will be non-critical functions in nature. If the function fails, the UAV will still be able to operate safely. The UAV secondary computer system 302 can include operating system 372. In some implementations, the operating system 372 can be based on real time operating system (RTOS), UNIX, LINUX, OS X, WINDOWS, ANDROID or other operating system.

Additionally, other software modules and applications may run on the operating system 372, such as an inspection module 374, database module 376, mission module 378 and contingency module 380. In particular, inspection module 374 can include computer instructions that, when executed by processor 394, can cause processor 394 to control the UAV to perform solar panel inspection operations as described below. Operating system 372 may include instructions for handling basic system services and for performing hardware dependent tasks.

The UAV can include controllers 346. Controllers 346 may be used to interact with and operate a payload device 348, and other devices such as cameras 349A and 349B. Cameras 349A and 349B can include a still-image camera, video camera, infrared camera, multispectral camera, stereo camera pair. In addition, controllers 346 may interact with a Lidar, radio transceiver, sonar, laser ranger, altimeter, TCAS, ADS-B (Automatic dependent surveillance-broadcast) transponder. Optionally, the secondary computer system 302 may have controllers to control payload devices.

The UAV 102 illustrated in FIGS. 1-3 is an example provided for illustrative purposes. The UAV 102 in accordance with the present disclosure may include more or fewer components than are shown. For example, while a quadcopter is illustrated, the UAV 102 is not limited to any particular UAV configuration and may include hexacopters, octocopters, fixed wing aircraft, or any other type of independently maneuverable aircraft, as will be apparent to those of skill in the art having the benefit of the disclosure herein. Furthermore, the navigation of an autonomous UAV 102 may be guided by other types of vehicles (e.g., spacecraft, land vehicles, watercraft, submarine vehicles, etc.).

The following paragraphs describe a multi-radio communication system for drones that selectively transmits or receives data over multiple communication links, such as a cellular network and a point-to-point (P2P) wireless network, concurrently, to improve communication reliability or throughput.

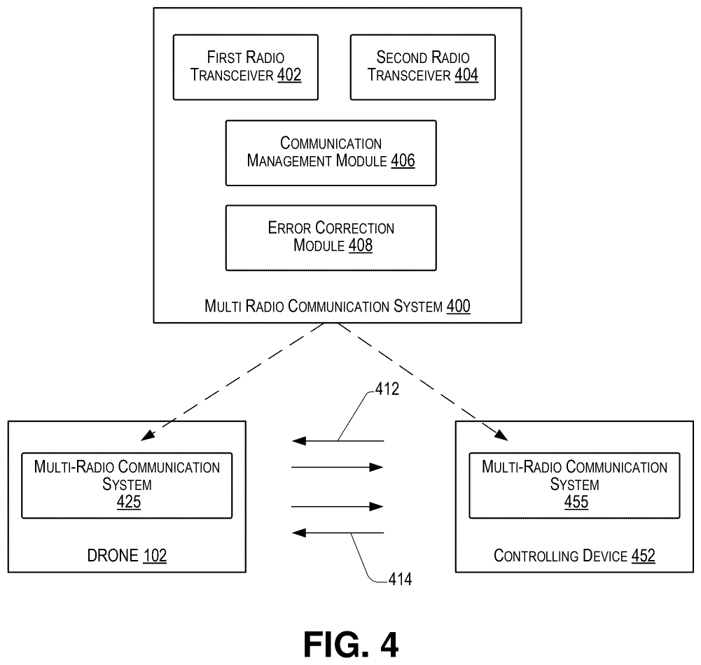

FIG. 4 illustrates a multi-radio communication system for drones, consistent with various embodiments. The multi-radio communication system 400 (also referred to as “communication system” 400) includes two or more radio transceivers operating with different radio technologies. In some embodiments, a first radio transceiver 402 is a cellular transceiver configured for data transmission and reception over a cellular network, such as LTE, 5G or other cellular network protocols. In some embodiments, a second radio transceiver 404 is a P2P wireless transceiver configured for communication over a P2P wireless network, such as Wi-Fi (e.g., 2.4 GHz, 5 GHz) or other proprietary RF protocols. The cellular transceiver 402 may operate in conjunction with the P2P transceiver 404 to form a dual-radio communication system that enhances reliability and throughput. Concurrent activation of both transceivers enables simultaneous data transmission and reception. This concurrent activation allows for the dynamic allocation of data to both transceivers based on various conditions (e.g., operational context parameter, communication link quality metric, etc.), as described below.

In some embodiments, the communication system 400 is implemented in both a drone (e.g., as multi-radio communication system 425 in a drone, such as the UAV 102) and a controlling device (e.g., as multi-radio communication system 455 within controlling device 452), thereby enhancing communication reliability and throughput in a bidirectional communication between the drone 102 and controlling device 452. The controlling device 452 may be a computing device, such as a mobile phone, or a ground control station (GCS) used to issue mission instructions to the drone 102.

In some embodiments, the transceivers 402 and 404 may be part of radio transceivers 359 of the UAV 102. The communication management module 406 and error correction module 408 may be implemented as separate modules in the operating system 320, or may be integrated with one of the existing modules, for example, mission module 329 of the UAV 102.

The communication system 400 includes a communication management module 406 configured to determine a transmission mode and selectively assign data packets to one or both transceivers. For example, in a single-mode transmission, data transmission or reception occurs through only one transceiver, while in a multi-mode transmission, data transmission or reception occurs through both transceivers concurrently. The communication management module 406 activates one transceiver for single-mode communication or both transceivers for multi-mode communication. The multi-mode transmission includes a cooperative mode and a redundant mode.

In the co-operative mode, non-redundant data packets are allocated to, or transmitted over, both the communication links, concurrently. For example, a message may be transmitted by sending a first portion over the first communication link 412 (e.g., cellular network 412) using cellular transceiver 402 and a second portion over the second communication link 414 (e.g., Wi-Fi network 414) using P2P transceiver 404, concurrently.

In the redundant mode, identical data packets are allocated to, or transmitted over, both the communication links, concurrently. For example, the same message (all data packets of the message) may be transmitted over the cellular network 412 and Wi-Fi network 414, concurrently.

The communication management module 406 enables concurrent transmission of identical or distinct data packets over the cellular transceiver 402 and the Wi-Fi transceiver 404. This selective use of cooperative or redundant transmission modes allows optimization of data flow, whether from the controlling device 452 to the drone 102, or from the drone 102 to the controlling device 452, by either increasing throughput or enhancing redundancy. Through this cooperative and redundant communication strategy, the communication system 400 leverages the complementary strengths of LTE and Wi-Fi, or 5G and proprietary RF technologies, to improve overall system performance.

Accordingly, the communication management module 406 manages and optimizes data transmission based on multiple parameters, including operational context parameters indicative of mission requirements, communication link quality metrics, geofencing parameters, data content type, application type, etc. Data packets are selectively assigned to the cellular transceiver 402 and the P2P transceiver 404 to maximize transmission efficiency. The communication management module 406 assesses communication link quality metrics such as signal strength, interference, and bandwidth availability to dynamically allocate data across available links. This dynamic allocation includes switching between cooperative and redundant modes, or even between single-mode transmission and multi-mode transmission, in response to changing network conditions, thereby maintaining reliable communication. By performing these adaptive functions, the communication management module 406 ensures efficient and robust operation of the communication system under varying drone mission scenarios. Unlike traditional multipath TCP (MPTCP) or VPN bonding solutions, which replicate socket-level sessions and operate primarily at the transport layer, the system described herein operates at the application-aware packet routing level. This avoids the complexity and overhead of end-to-end session duplication and enables faster, more flexible switching tailored to drone mission-critical control and telemetry data.

The communication system 400 includes an error correction module 408 configured to aggregate received data packets to ensure data integrity. This error correction mechanism is useful in environments where data packet loss or corruption is likely. By aggregating data received from both the cellular transceiver 402 and P2P transceiver 404, the communication system 400 enhances communication link reliability. In some embodiments, the error correction module 408 employs error detection and correction techniques, such as Reed-Solomon coding and automatic repeat request (ARQ), to maintain data integrity. The error correction module 408 reconstructs the original message by aggregating data packets received across both transceivers. For example, when different portions of a message are received by different transceivers, the error correction module 408 reconstructs the original message through data packet aggregation. In another example, even if identical data packets are sent across both the transceivers, the error correction module 408 identifies any packet loss on a particular transceiver and retrieves the missing data packet from the other transceiver to reconstruct the original message.

Through concurrent activation of the transceivers, dynamic data allocation, and error correction, the communication system 400 may adapt to various operational scenarios, ensuring reliable data communication in applications such as urban search and rescue, long-range public safety surveillance, and tactical deployments.

The following paragraphs describe selective data transmission strategies based on various operational and communication conditions.

In some embodiments, the transmission mode is determined based on an operational context parameter indicative of mission-specific operational requirements, such as reliability, throughput, latency, power consumption, etc. For example, when throughput is prioritized, the communication system 400 may operate in a cooperative mode by transmitting different portions of message (e.g., non-identical, unique data packets) over different communication links, concurrently.

In another example, when reliability is the priority, the communication system 400 may operate in a redundant mode by transmitting identical data packets over both the communication links, concurrently.

In another example, when power consumption is prioritized, the communication system 400 may switch to a single-mode transmission, using one of the two transceivers, e.g., Wi-Fi transceiver 404, that consumes lesser power among the transceivers, to conserve power.

In some embodiments, the communication management module 406 may allocate data to one or both transceivers based on a communication link quality metric like signal strength, interference, bandwidth availability, error rate, retransmission count, etc. For example, redundant mode transmission may be selected when the signal strength of either communication link falls below a predefined threshold, thereby reducing the likelihood of packet loss. Conversely, co-operative mode transmission may be used when signal strength or other quality metrics for both links exceed required thresholds, thereby increasing throughput.

The communication management module 406 may determine an optimal transmission strategy by dynamically switching transmission modes to adapt to varying network conditions. This adaptability may be achieved through continuous or real-time evaluation of communication link quality metrics, allowing data to be allocated to the most suitable radio link. For example, when the signal strength of both communication links 412 and 414 exceeds specified thresholds, the communication management module 406 may switch from redundant mode to co-operative mode to improve throughput.

In another example, the communication management module 406 may switch to a single-mode transmission and transmit data using the cellular transceiver 402 when a communication link quality metric like interference is above a specified threshold.

In another example, the communication management module 406 is configured to prioritize data transmission over the Wi-Fi network 414 when latency measurements for the Wi-Fi network are lower than a defined latency threshold for the cellular network 412.

In another example, the communication management module 406 is configured to transmit in co-operative mode when both networks meet minimum signal integrity and bandwidth thresholds.

In another example, the communication management module 406 is configured to dynamically reduce transmission over the cellular network 412 when a data usage quota or cost constraint is detected.

In another example, the communication management module 406 switches transmission to the cellular network 412 in response to a detected handoff event or disassociation from the Wi-Fi access point.

In another example, the communication management module 406 continuously monitors error rate and retransmission counts on each communication link and reallocates traffic accordingly to reduce packet loss.

In another example, the communication management module 406 continuously monitors bandwidth utilization on each communication link and upon detecting asymmetry in available bandwidth exceeding a defined threshold, dynamically switches data transmission to cooperative mode to distribute different segments of the data stream proportionally across the cellular and Wi-Fi networks.

In another example, the communication management module 406 uses a weighted scoring algorithm based on multiple communication link metrics including throughput, jitter, and packet delivery ratio to select a preferred primary communication link.

In another example, the communication management module 406 dynamically transitions between redundant and unique data transmission modes based on a composite link quality score computed from metrics including jitter, round-trip time, and packet error rate.

In another example, the communication management module 406 uses a moving average of bit error rate (BER) on either communication link to predict degradation, and proactively switches from cooperative to redundant mode when degradation exceeds a threshold for a predefined time window.

In some embodiments, the communication management module 406 may allocate data to one or both transceivers based on geo-fencing parameters or policies. The geofenced regions may be defined in the communication management module 406 using GPS coordinates, and link switching logic may be triggered based on the drone position relative to those boundaries. For example, the communication management module 406 is configured to switch transmission exclusively to the cellular network 412 when the drone 102 enters a predefined geofenced area associated with restricted Wi-Fi availability. This drone-specific, location-aware policy enforcement differentiates the system from conventional multi-WAN routers or signal-bonding platforms, which lack geospatial transmission control tailored to airspace or mission phase.

In another example, the communication management module 406 is configured to preemptively reduce Wi-Fi transmission power or bandwidth when the drone 102 is detected to be approaching a boundary of a geofenced Wi-Fi coverage area.

In another example, the communication management module 406 applies geofenced policies to restrict redundant data transmission in low-interference zones or enable redundant transmission in zones marked as high-risk.

In some embodiments, the communication management module 406 may allocate data to one or both transceivers based on predictive switching. For example, the communication management module 406 uses historical signal strength patterns correlated with GPS coordinates to predictively switch transmission from one communication link to another before signal degradation occurs.

In another example, the communication management module 406 employs a machine learning model trained on prior flight data to forecast network performance and dynamically allocate data between the cellular and Wi-Fi networks.

In another example, the communication management module 406 monitors drone velocity, trajectory, and altitude to predict upcoming network coverage gaps and initiate preemptive link switching.

In another example, the communication management module 406 buffers critical control data when entering areas predicted to have temporary communication blackouts, and resumes transmission post-recovery.

The above examples show how spatial awareness (e.g., geofencing) and temporal forecasting (e.g., predictive switching) can work together to create a resilient, self-adapting communication link.

In some embodiments, the communication management module 406 may allocate data to one or both transceivers based on data content being transmitted. This enables, for example, redundant transmission of command-and-control messages while offloading media streaming to cooperative throughput-maximizing channels. Such per-application transmission strategy is not present in typical network bonding tools, which treat all traffic uniformly and lack awareness of flight-critical priorities. For example, the communication management module 406 is configured to transmit the control data in redundant mode over both the cellular and Wi-Fi networks, while transmitting payload data in co-operative mode across the two networks, thereby ensuring real-time command responsiveness while maximizing data throughput.

In another example, the communication management module 406 categorizes data into latency-sensitive and latency-tolerant classes and applies redundant mode transmission only to the latency-sensitive class.

In some embodiments, the communication management module 406 may allocate data to one or both transceivers based on frame-level partitioning. For example, the communication management module 406 is configured to partition a single data frame into time-stamped segments and transmit non-overlapping segments simultaneously over the cellular network 412 and the Wi-Fi network 414, followed by recombination and integrity validation at the receiving end. In some embodiments, redundant and unique transmission strategies are applied at a per-packet granularity, such that a control frame's header is transmitted redundantly while the payload is distributed across both networks to optimize overhead and robustness.

In some embodiments, the communication management module 406 may allocate data to one or both transceivers based on an application that is transmitting or receiving the data. For example, the communication management module 406 receives application-level transmission policies specifying whether telemetry, control, or media data should be prioritized for redundancy or throughput, and dynamically applies these policies based on mission phase or user-defined parameters.

In some embodiments, the communication management module 406 may allocate data to one or both transceivers based on network encoding. For example, the communication management module 406 transmits an error-protected version of a data stream over the cellular network 412 and a compressed version over the Wi-Fi network 414, enabling reconstruction of the original stream from either or both transmissions depending on link availability.

In another example, redundant data packets are encoded using complementary error-correction codes on cellular and Wi-Fi communication links respectively, enabling cross-validation and forward error correction based on multi-path diversity.

In some embodiments, the communication management module 406 determines the appropriate transmission mode at various granularities, including individual data packets, entire messages comprising multiple packets, or entire sessions involving multiple message transmissions. In certain implementations, transitions between transmission modes follow a hysteresis model that mitigates rapid toggling by enforcing a persistence requirement, where communication link quality conditions must remain above or below predefined thresholds for a specified time window before a mode change is triggered.

The selection of transmission mode may occur within either the drone 102 or the controlling device 452. For example, when the data transmission is from the controlling device 452, the communication system 455 of the controlling device 452 may determine the transmission mode. Conversely, when the data is transmitted from the drone 102, the communication system 425 of the drone 102 may select the appropriate transmission mode. In yet another example, the communication system 425 of the drone 102 may instruct the controlling device 452 to apply a particular transmission mode.

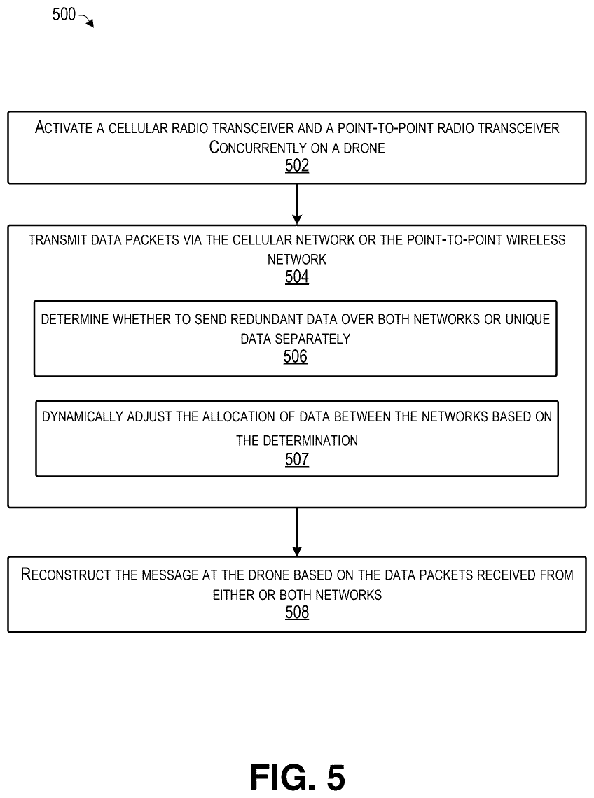

FIG. 5 is a flow diagram of a method for enhancing drone communication using multi-radio technologies, consistent with various embodiments. In some embodiments, the method 500 may be implemented in the environment of FIG. 4 and by the UAV 102.

At block 502, the communication system 425 activates multiple radio transceivers of the drone 102. These transceivers operate on different technologies or standards. For example, the communication system 425 may include a cellular transceiver that supports LTE, 5G or other cellular network protocols. The communication system 425 may also include a P2P wireless transceiver, such as a Wi-Fi transceiver operating on 2.4 GHz, 5 GHz, or other P2P wireless protocols. The communication system 425 may activate both transceivers concurrently to enable concurrent data transmission and reception by the drone 102.

At block 504, the controlling device 452 transmits a message, e.g., as data packets, to the drone 102 using at least one of available communication networks, including the cellular network 412 or the Wi-Fi network 414 (or any other P2P wireless network). In some embodiments, the controlling device 452 determines a transmission mode for transmitting the data to the drone 102 (block 506). The transmission mode, as described above, includes a single-mode transmission, in which the data is transmitted over one of the two networks, or a multi-mode transmission, in which the data is transmitted over both the networks concurrently. Further, in the multi-mode transmission, the data may be transmitted in (a) a co-operative mode, where unique, non-redundant data packets are transmitted over both the communication networks, or (b) a redundant mode, where identical data packets are transmitted over both the communication networks. The communication system 455 of the controlling device 452 selects the transmission mode based one or more parameters, such as operational context parameter indicative of operational requirements, communication link quality metric, geo-fencing parameter, data content type, application type, etc., as previously described at least with reference to FIG. 4.

At block 507, the communication system 455 of the controlling device 452 dynamically adjusts the allocation of data between the communication networks based on the selected transmission mode, enabling optimized transmission to the drone 102.

At block 508, the drone 102 receives the transmitted data packets. The communication system 425 of the drone 102 reconstructs the original message by aggregating the data packets received from either or both the communication networks. An error correction module within the communication system 425 performs this aggregation to ensure data integrity. For example, when different portions of the message are received over different networks, the error correction module aggregates those data packets to reconstruct the original message. In another example, if identical data packets are sent across both the networks, the error correction module detects any packet loss on one network, retrieves the missing data packet from the other network, and aggregates the data packets to reconstruct the original message.

Accordingly, the multi-radio drone communication system, through concurrent activation of the transceivers, dynamic data allocation, and integrated error correction, adapts to various operational scenarios, ensuring robust communication in mission-critical applications such as urban search and rescue, long-range public safety surveillance, and tactical deployments.

The following paragraphs describe some of the technical features and benefits of the multi-radio drone communication system.

The communication system reduces the risk of performance issues under certain conditions by utilizing two separate radio technologies, such as a cellular network and a P2P wireless network, for communication between a controlling device and a drone, rather than relying on a single radio technology.

The communication system increases the reliability and throughput by using the cellular and P2P wireless networks in redundant and cooperative configurations. Instead of selecting a single radio for data transmission, data is transmitted over both radios simultaneously. Depending on operational conditions, the transmitted data may be redundant or unique, with the configuration dynamically optimized to meet specific performance requirements.

The communication system leverages the combined use of cellular and P2P wireless networks to harness the advantages of both technologies while mitigating their respective limitations. Cellular network may provide long-range communication capabilities, whereas Wi-Fi may support high-speed data transfer over short distances. By operating both radios in parallel, the system benefits from the complementary strengths of each technology.

The communication system enhances the robustness and reliability of communication links by reducing the potential for data loss or signal interruptions. Simultaneous use of cellular and P2P wireless networks may create a resilient communication channel capable of maintaining consistent performance under varying network conditions.

By fully utilizing the capabilities of both cellular and P2P wireless networks, the communication system optimizes resource use, resulting in improved overall reliability and increased data-handling capacity. This allows the system to accommodate higher traffic volumes without compromising transmission speed or stability.

By sending data over both cellular and P2P wireless networks at once, the communication system can significantly increase the overall throughput of the system. This is particularly beneficial for applications such as package delivery, where high data rates are required to transfer large amounts of data quickly and efficiently.

The communication system allows for the data to be either redundant or unique, depending on what is optimal for a given situation. This provides flexibility and adaptability, which is particularly beneficial in dynamic environments such as urban areas, where the communication conditions can change rapidly.

While generic bonded-radio solutions exist in networking contexts (e.g., commercial routers or streaming encoders), the system described herein addresses a distinct aviation-specific challenge by incorporating control-mode prioritization, geo-spatial rules, and predictive adaptation to link health-all of which are essential for UAV operations. These features support high-reliability remote flight operations, including beyond visual line of sight (BVLOS) or emergency contingency handling, which require tighter latency, redundancy, and failure resilience than general-purpose bonding systems provide.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately)) 225°. The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

The present techniques will be better understood with reference to the following enumerated embodiments:

1. A communication system for a drone, comprising:
a controlling device comprising a first dual-mode radio module operable to transmit and receive data via both a cellular network and a Wi-Fi network;
a drone comprising a second dual-mode radio module operable to transmit and receive data via both the cellular network and the Wi-Fi network; and
a communication management module configured to:
   (a) transmit operational data from the controlling device to the drone over both the cellular network and the Wi-Fi network simultaneously;
   (b) dynamically select, for a given data packet, whether to transmit the same data redundantly or different data uniquely across the cellular network and the Wi-Fi network; and
   (c) monitor network performance parameters including signal strength, interference, and data traffic load to optimize throughput and connection reliability during drone operation.

2. The system of any of the preceding embodiments, wherein the cellular network is a Long-Term Evolution (LTE) network and the Wi-Fi network operates at 2.4 GHz or 5 GHz frequency bands.

3. The system of any of the preceding embodiments, wherein the communication management module performs link selection and load balancing based on real-time signal quality metrics.

4. The system of any of the preceding embodiments, wherein the communication management module includes error detection and correction logic implementing Reed-Solomon coding or automatic repeat request (ARQ) protocols.

5. The system of any of the preceding embodiments, wherein the controlling device and the drone are each commercial off-the-shelf devices configured with the dual-mode radio module and the communication management module implemented in software.

6. The system of any of the preceding embodiments, wherein the communication management module is configured to switch data transmission from the Wi-Fi network to the cellular network when a received signal strength indicator (RSSI) for the Wi-Fi network falls below a predefined threshold.

7. The system of any of the preceding embodiments, wherein the communication management module is configured to prioritize data transmission over the Wi-Fi network when latency measurements for the Wi-Fi network are lower than a defined latency threshold for the cellular network.

8. The system of any of the preceding embodiments, wherein the communication management module is configured to transmit data redundantly over both networks when a signal quality metric for either network falls below a predefined reliability margin.

9. The system of any of the preceding embodiments, wherein the communication management module is configured to transmit unique, non-redundant data over both networks when both networks meet minimum signal integrity and bandwidth thresholds.

10. The system of any of the preceding embodiments, wherein the communication management module is configured to dynamically reduce transmission over the cellular network when a data usage quota or cost constraint is detected.

11. The system of any of the preceding embodiments, wherein the communication management module switches transmission to the cellular network in response to a detected handoff event or disassociation from the Wi-Fi access point.

12. The system of any of the preceding embodiments, wherein the communication management module continuously monitors error rate and retransmission counts on each network and reallocates traffic accordingly to reduce packet loss.

13. The system of any of the preceding embodiments, wherein the communication management module uses a weighted scoring algorithm based on multiple link parameters including throughput, jitter, and packet delivery ratio to select a preferred primary link.

14. The system of any of the preceding embodiments, wherein the communication management module is configured to switch transmission exclusively to the cellular network when the drone enters a predefined geofenced area associated with restricted Wi-Fi availability.

15. The system of any of the preceding embodiments, wherein the communication management module is configured to preemptively reduce Wi-Fi transmission power or bandwidth when the drone is detected to be approaching a boundary of a geofenced Wi-Fi coverage area.

16. The system of any of the preceding embodiments, wherein geofenced regions are defined in the communication module using GPS coordinates, and link switching logic is triggered based on drone position relative to those boundaries.

17. The system of any of the preceding embodiments, wherein the communication management module applies geofenced policies to restrict redundant data transmission in low-interference zones or enable redundant transmission in zones marked as high-risk.

18. The system of any of the preceding embodiments, wherein the communication management module uses historical signal strength patterns correlated with GPS coordinates to predictively switch transmission from one network to another before signal degradation occurs.

19. The system of any of the preceding embodiments, wherein the communication management module employs a machine learning model trained on prior flight data to forecast network performance and dynamically allocate data between the cellular and Wi-Fi networks.

20. The system of any of the preceding embodiments, wherein the communication management module monitors drone velocity, trajectory, and altitude to predict upcoming coverage gaps and initiate preemptive link switching.

21. The system of any of the preceding embodiments, wherein the communication management module buffers critical control data when entering areas predicted to have temporary communication blackouts, and resumes transmission post-recovery.

22. The system of any of the preceding embodiments, wherein the communication management module is configured to transmit the same control data redundantly over both the cellular and Wi-Fi networks while transmitting payload data uniquely across the two networks, thereby ensuring real-time command responsiveness while maximizing data throughput.

23. The system of any of the preceding embodiments, wherein the communication management module categorizes data into latency-sensitive and latency-tolerant classes and applies redundant transmission only to the latency-sensitive class.

24. The system of any of the preceding embodiments, wherein the communication management module dynamically transitions between redundant and unique data transmission modes based on a composite link quality score computed from metrics including jitter, round-trip time, and packet error rate.

25. The system of any of the preceding embodiments, wherein the communication management module uses a moving average of bit error rate (BER) on either link to predict degradation, and proactively switches from unique to redundant mode when degradation exceeds a threshold for a predefined time window.

26. The system of any of the preceding embodiments, wherein the communication management module is configured to partition a single data frame into time-stamped segments and transmit non-overlapping segments simultaneously over the LTE and Wi-Fi networks, followed by recombination and integrity validation at the receiving end.

27. The system of any of the preceding embodiments, wherein redundant and unique transmission strategies are applied at a per-packet granularity, such that a control frame's header is transmitted redundantly while the payload is distributed across both networks to optimize overhead and robustness.

28. The system of any of the preceding embodiments, wherein the communication management module receives application-level transmission policies specifying whether telemetry, control, or media data should be prioritized for redundancy or throughput, and dynamically applies these policies based on mission phase or user-defined parameters.

29. The system of any of the preceding embodiments, wherein the communication management module transmits an error-protected version of a data stream over the LTE network and a lightly compressed version over the Wi-Fi network, enabling reconstruction of the original stream from either or both transmissions depending on link availability.

30. The system of any of the preceding embodiments, wherein redundant data packets are encoded using complementary error-correction codes on LTE and Wi-Fi links respectively, enabling cross-validation and forward error correction based on multi-path diversity.

31. A communication system for a drone, comprising:
a cellular transceiver configured to transmit and receive data over a cellular network;
a point-to-point transceiver configured to transmit and receive data over a point-to-point wireless link; and
a communication management module configured to:
   selectively transmit data packets over each transceiver based on operational requirements, and
   optimize data transmission by the selective transmission of the data packets.

32. The communication system of any of the preceding embodiments, wherein the cellular network and the point-to-point wireless link comprise at least one of LTE and Wi-Fi, or 5G and proprietary RF.

33. The communication system of any of the preceding embodiments, wherein the communication management module is further configured to:
determine communication link quality parameters, and
dynamically allocate data to one or both transceivers based on the communication link quality parameters.

34. The communication system of any of the preceding embodiments, wherein the communication link quality parameters comprise at least one of signal strength, interference, or bandwidth availability.

35. The communication system of any of the preceding embodiments, further comprising:
an error correction mechanism configured to aggregate received data packets across both the cellular transceiver and the point-to-point transceiver.

36. The communication system of any of the preceding embodiments, wherein the communication management module is further configured to activate the cellular transceiver and the point-to-point transceiver concurrently.

37. The communication system of any of the preceding embodiments, wherein the operational requirements comprise at least one of reliability, throughput, latency, or power consumption.

38. The communication system of any of the preceding embodiments, wherein the communication management module is further configured to transmit identical data packets over each transceiver for redundancy.

39. The communication system of any of the preceding embodiments, wherein the communication management module is further configured to transmit distinct data packets over each transceiver for increased throughput.

40. The communication system of any of the preceding embodiments, wherein the drone is configured for at least one of urban search and rescue, long-range public safety surveillance, or tactical deployments.

41. A dual-radio drone system, comprising:
a drone communication system comprising a cellular transceiver and a point-to-point transceiver; and a drone communication manager configured to selectively transmit data packets over each transceiver based on operational requirements to optimize data transmission.

42. The dual-radio drone system of any of the preceding embodiments, wherein the drone communication system uses a cooperative and redundant communication approach comprising at least one of LTE and Wi-Fi, or 5G and proprietary RF.

43. The dual-radio drone system of any of the preceding embodiments, wherein the cellular transceiver and the point-to-point transceiver are configured to transmit and receive data concurrently.

44. The dual-radio drone system of any of the preceding embodiments, wherein the drone communication manager is further configured to:
determine communication link quality parameters, and
dynamically allocate data to one or both transceivers based on the communication link quality parameters.

45. The dual-radio drone system of any of the preceding embodiments, further comprising:
a drone error correction module configured to aggregate received data packets across both the cellular transceiver and the point-to-point transceiver.

46. A method for enhancing communication reliability and throughput between a controlling device and a drone, the method comprising:
transmitting data from the controlling device to the drone simultaneously via both a cellular network and a Wi-Fi network;
determining, for each data transmission instance, whether to send redundant data over both networks or unique data separately;
monitoring real-time communication parameters to dynamically adjust the allocation of data between the networks; and
receiving the transmitted data at the drone and reconstructing the original message based on received packets from either or both networks.

47. The method of any of the preceding embodiments further comprising:
evaluating an operational context parameter selected from a group consisting of: (i) emergency override status, (ii) flight phase identifier, and (iii) task-criticality flag; and
in response to detecting a high-criticality context, switching the data transmission mode from unique to redundant across the cellular and Wi-Fi networks.

48. The method of any of the preceding embodiments, wherein switching from redundant mode to unique mode is triggered when a link stability score computed from weighted averages of signal-to-noise ratio (SNR), round-trip time (RTT), and packet delivery rate (PDR) exceeds a predefined reliability threshold for both networks.

49. The method of any of the preceding embodiments, further comprising:
monitoring bandwidth utilization on each radio link; and
upon detecting asymmetry in available bandwidth exceeding a defined threshold, dynamically switching to unique mode to distribute different segments of the data stream proportionally across the cellular and Wi-Fi networks.

50. The method of any of the preceding embodiments, wherein the transition between redundant and unique transmission modes is based on a hysteresis model that prevents rapid toggling by requiring persistence of quality conditions above or below threshold values for a time duration window before switching modes.

51. The method of any of the preceding embodiments, further comprising:
prioritizing telemetry and command data for redundant transmission during low link quality conditions,
and concurrently transmitting sensor payload or video stream data in unique mode when both communication links support minimum throughput and latency requirements.

52. A non-transitory computer-readable medium storing instructions that, when executed by one or more processors of a drone communication system, cause the system to:
communicate via both a cellular network and a Wi-Fi network in parallel; send control or telemetry data over both networks either redundantly or uniquely; and
adaptively adjust transmission strategies based on real-time network conditions to maintain connection reliability and maximize data throughput.

53. A tangible, non-transitory, machine-readable medium storing instructions that, when executed by a data processing apparatus, cause the data processing apparatus to perform operations comprising those of any of embodiments 1-52.

54. A system comprising: one or more processors; and memory storing instructions that, when executed by the processors, cause the processors to effectuate operations comprising those of any of embodiments 1-52.

55. A system comprising means for performing any of embodiments 1-52.

What is claimed is:

1. A communication system for a drone, comprising:
a first radio transceiver configured for operation over a cellular network;
a second radio transceiver configured for operation over a point-to-point wireless network; and
a communication management module configured to:
determine a transmission mode for transmitting data packets using both the transceivers concurrently, the transmission mode including a co-operative mode in which distinct data packets are transmitted over each transceiver, or a redundant mode in which identical data packets are transmitted over each transceiver, and
cause selective transmission of the data packets over each transceiver based on the transmission mode.

2. The communication system of claim 1, wherein the communication management module is configured to determine the transmission mode based on an operational context parameter, the operational context parameter indicative of at least one of reliability, throughput, latency, or power consumption.

3. The communication system of claim 1, wherein the communication management module is configured to cause data transmission in the redundant mode for reliability.

4. The communication system of claim 1, wherein the communication management module is configured to cause data transmission in the co-operative mode for increased throughput.

5. The communication system of claim 1, wherein the communication management module is further configured to:
determine a communication link quality metric, and
determine the transmission mode based on the communication link quality metric.

6. The communication system of claim 5, wherein the communication link quality metric includes at least one of signal strength, interference, or bandwidth availability.

7. The communication system of claim 1, wherein the communication management module is configured to cause data transmission in the redundant mode when a communication link quality metric for either network falls below a predefined threshold.

8. The communication system of claim 1, wherein the communication management module is configured to cause data transmission in the co-operative mode when a communication link quality metric of both networks meet specified thresholds.

9. The communication system of claim 1, wherein the cellular network includes at least one of LTE or 5G, and the point-to-point wireless network includes at least one of Wi-Fi or proprietary radio frequency (RF) signal.

10. The communication system of claim 1 further comprising:
an error correction mechanism configured to aggregate received data packets across both the first radio transceiver and the second radio transceiver.

11. The communication system of claim 1, wherein the communication management module is further configured to:
activate the first radio transceiver and the second radio transceiver concurrently.

12. A method for enhancing communication reliability in a drone, the method comprising:
activating a cellular radio transceiver and a point-to-point radio transceiver on a drone for enabling communication using a cellular network and a point-to-point wireless network;
transmitting data packets of a message from a controlling device to the drone via at least one of the cellular network and the point-to-point wireless network, wherein the transmitting includes:
determining, for each data transmission instance, a transmission mode, the transmission mode indicating whether to send data over both networks concurrently or one of the networks, and
dynamically adjusting allocation of data between the networks based on the transmission mode; and
reconstructing the message at the drone based on the data packets received from either or both networks.

13. The method of claim 12, wherein the transmission mode is determined based on an operational context parameter or a communication link quality metric.

14. The method of claim 13, wherein the operational context parameter is indicative of at least one of reliability, throughput, latency, or power consumption.

15. The method of claim 13, wherein the communication link quality metric includes at least one of signal strength, interference, or bandwidth availability.

16. The method of claim 13, wherein transmitting the data packets includes:
transmitting the data packets redundantly using both networks when a communication link quality metric for either network falls below a predefined threshold.

17. The method of claim 13, wherein transmitting the data packets includes:
transmitting the data packets as unique, non-redundant data packets over both networks when a communication link quality metric of both networks meets specified thresholds.

18. An autonomous unmanned aerial vehicle (UAV) comprising:
one or more sensors configured to capture perception inputs of a physical environment;
a propulsion system configured to maneuver the UAV through the physical environment;
a communication system including:
a first radio transceiver configured for operation over a cellular network, and
a second radio transceiver configured for operation over a point-to-point wireless network; and
a communication management module configured to:
select a transmission mode for transmitting data packets using both the transceivers, the transmission mode including a co-operative mode in which distinct data packets are transmitted over each transceiver, or a redundant mode in which identical data packets are transmitted over each transceiver.

19. The autonomous UAV of claim 18, wherein the communication management module is configured to:
determine a communication link quality metric, and
dynamically select the transmission mode based on the communication link quality metric.

20. The autonomous UAV of claim 18, wherein the first radio transceiver and the second radio transceiver are configured to transmit and receive data concurrently using LTE and Wi-Fi, or 5G and proprietary radio frequency (RF).
